(19) United States
(12) Patent Application Publication
(10) Pub. No.: US 2010/0103459 A1
(43) Pub. Date: Apr. 29, 2010

(54) IMAGE PROCESSING APPARATUS, DOCUMENT NUMBER ADDING METHOD, AND STORAGE MEDIUM

(75) Inventor: Toru Wakana, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/606,019

(22) Filed: Oct. 26, 2009

(30) Foreign Application Priority Data
Oct. 27, 2008 (JP) 2008-275977

(51) Int. Cl. G06F 15/00

(52) U.S. Cl. 358/1.15; 358/1.18

(57) ABSTRACT

An information processing apparatus includes a setting unit configured to set adding a document number indicating a copy number and executing a page iterative imposition for imposing a plurality of same pages on a plane of a sheet (i.e., a physical page) and a document number adding unit configured to add different document numbers on logical pages to be imposed on the physical page according to contents set by the setting unit so that a plurality of same logical pages can be imposed on the plane of the sheet (i.e., the physical page).

### BACKGROUND OF THE INVENTION

1. Field of the Invention

The present invention relates to an image processing apparatus, a document number adding method, and a program.

2. Description of the Related Art

A multi-function machine, such as a multi-function peripheral (MFP) capable of realizing a plurality of functions, can use copy/printer functions and other various functions. One of the functions that can be realized by the MFP is a document number printing function. The document number printing function is a function for printing document numbers (i.e., serial numbers) on printed documents when a plurality of copies of an original are printed.

For example, when an original including three pages is generated as illustrated in FIG. 29, the MFP can print three sets of copies of the original using the document number printing function and can obtain a print result as illustrated in FIG. 30.

FIG. 29 illustrates an example of the original including three pages. FIG. 30 illustrates an example of the print result of three sets of copies of the original including three pages illustrated in FIG. 29, which can be obtained by using the document number printing function.

As illustrated in FIG. 30, for example, a document number “0001” is printed (added) on the first document, a document number “0002” is printed on the second document, and a document number “0003” is printed on the third document.

The document number printing function can be used, for example, in a situation where the MFP is used to print a plurality of copies of a confidential original and the printed documents are distributed to a plurality of members in a conference. In such a case, each distributed document can be managed based on a document number added to each document.

Further, in a case where a distributed document is copied by an unauthorized person, the document number printing function is useful to track and identify a member whose document is copied by unauthorized person.

Meanwhile, the MFP has various print assisting functions. One of the print assisting functions is a function for determining a layout of a plurality of pages to be imposed on apiece of sheet before the MFP starts a printing operation. This function can reduce a total number of sheets (or papers) required for the printing.

A similar print assisting function is a page iterative function. The page iterative function can be used when at least two same pages to be printed are imposed on a piece of sheet.

For example, if the page iterative function is applied to the three-page data illustrated in FIG. 29, a print result illustrated in FIG. 31 can be obtained. If the resulting printed product is cut into a plurality of documents by a cutting machine as illustrated in FIG. 32, two or more sets of copies (printed documents) of the original can be obtained as a final product of the printing operation that is performed only one time.

Recently, print job flows often included the above-described post processing that requires a cutting operation by the cutting machine to obtain a final product.

FIG. 31 illustrates an example of the print result of the original including three pages illustrated in FIG. 29, which can be printed using the page iterative function. FIG. 32 illustrates an example of a plurality of printed products, which can be obtained by cutting the print result illustrated in FIG. 31 using the cutting machine.

As discussed in Japanese Patent Application Laid-Open No. 2007-237591, a function for adding a document number to each logical page is available in a case where the document number printing function is used in combination with the function for printing a plurality of pages to be imposed on apiece of sheet.

However, according to the above-described technique discussed in Japanese Patent Application Laid-Open No. 2007-237591, the same document number is imposed on each of a plurality of pages to be imposed on a piece of sheet. Therefore, if a printed product obtained by combining the document number printing function with the page iterative function is cut into a plurality of pieces in the post processing (by the cutting machine), two or more printed products having the same document number may be produced as illustrated in FIG. 33. As a result, if the printed documents are distributed to a plurality of members in a conference, it becomes difficult to manage each distributed document.

### SUMMARY OF THE INVENTION

According to an exemplary embodiment of the present invention, the purpose of preventing a plurality of printed products having the same document number from being produced can be attained.

According to an aspect of the present invention, an information processing apparatus includes a setting unit configured to set printing document numbers that can be used to manage printed products on a document-by-document basis and executing a page iterative imposition for imposing a plurality of same pages on a plane of a sheet, and a generation unit configured to generate print data for printing the plurality of same pages on the plane of the sheet according to contents set by the setting unit, so that different document numbers are printed on respective printed products that can be obtained by cutting each sheet on which the plurality of same pages are printed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of a printing system.

FIG. 2 illustrates an example of an MFP.

FIG. 3 is a block diagram illustrating a configuration of each device that constructs the printing system.

FIG. 4 is a flowchart illustrating an example of printer processing that can be performed by the printing system.

FIG. 5 is a flowchart illustrating an example of PC processing.

FIG. 6 is a flowchart illustrating an example of driver processing.

FIG. 7 illustrates an example of a driver user interface (UI).

FIG. 8 is a flowchart illustrating an example of the printer processing (version I).

FIG. 9 is a flowchart illustrating an example of document number print processing.

FIG. 10 is a flowchart illustrating an example of document number determination processing (version I).

FIG. 11 is a flowchart illustrating an example of document number form generation processing.

FIG. 12 is a flowchart illustrating an example of document number page generation processing.

FIG. 13 illustrates an example of a print layout (version I).

FIG. 14 illustrates an example of form data (version I).

FIG. 15 illustrates an example of the form data (version II).

FIG. 16 illustrates an example of the form data (version III).

FIG. 17 illustrates an example of document number determination (version I).

FIG. 18 is a flowchart illustrating an example of the document number determination processing (version II).

FIG. 19 illustrates an example of the form data (version IV).

FIG. 20 is a flowchart illustrating an example of the document number determination processing (version III).

FIG. 21 illustrates an example of the form data (version V).

FIG. 22 illustrates an example of the document number determination (version II).

FIG. 23 illustrates an example of the document number determination (version III).

FIG. 24 illustrates an example of the print layout (version II).

FIG. 25 is a flowchart illustrating an example of copy processing that can be performed by the printing system.

FIG. 26 is a flowchart illustrating an example of reading processing.

FIG. 27 is a flowchart illustrating an example of the printer processing (version II).

FIG. 28 illustrates an example of a UI that can be used for settings of the copy processing.

FIG. 29 illustrates an example of an original including three pages.

FIG. 30 illustrates an example of a print result of three sets of copies of the original including three pages illustrated in FIG. 29, which can be obtained by using the document number printing function.

FIG. 31 illustrates an example of a print result of the original including three pages illustrated in FIG. 29, which can be printed using the page iterative function.

FIG. 32 illustrates an example of a plurality of printed products, which can be obtained by cutting the print result illustrated in FIG. 31 using the cutting machine.

FIG. 33 illustrates a problem of a conventional art.

### DESCRIPTION OF THE EMBODIMENTS

Various exemplary embodiments, features, and aspects of the invention will be described in detail below with reference to the drawings.

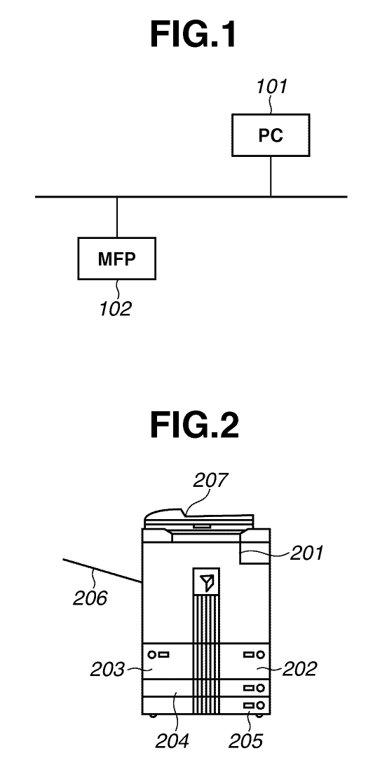

FIG. 1 illustrates an example of a system configuration of a printing system.

A host personal computer (PC) 101, which serves as an external device, can generate document data using an arbitrary application. A printer driver, which is installed on the host PC 101, can generate print data.

The printing system includes a MFP 102.

The MFP according to a first exemplary embodiment is described below with reference to FIG. 2. FIG. 2 illustrates an example of the MFP.

The MFP, which is an example of an image processing apparatus, has a main body 201.

A paper feeding deck 202 is equipped in the main body of the MFP.

Another paper feeding deck 203 is equipped in the main body of the MFP.

A paper feeding cassette 204 is equipped in the main body of the MFP.

Another paper feeding cassette 205 is equipped in the main body of the MFP.

A paper discharge tray 206 is equipped in the main body of the MFP.

An automatic document feeder and scanner 207 can read an original set on the main body of the MFP.

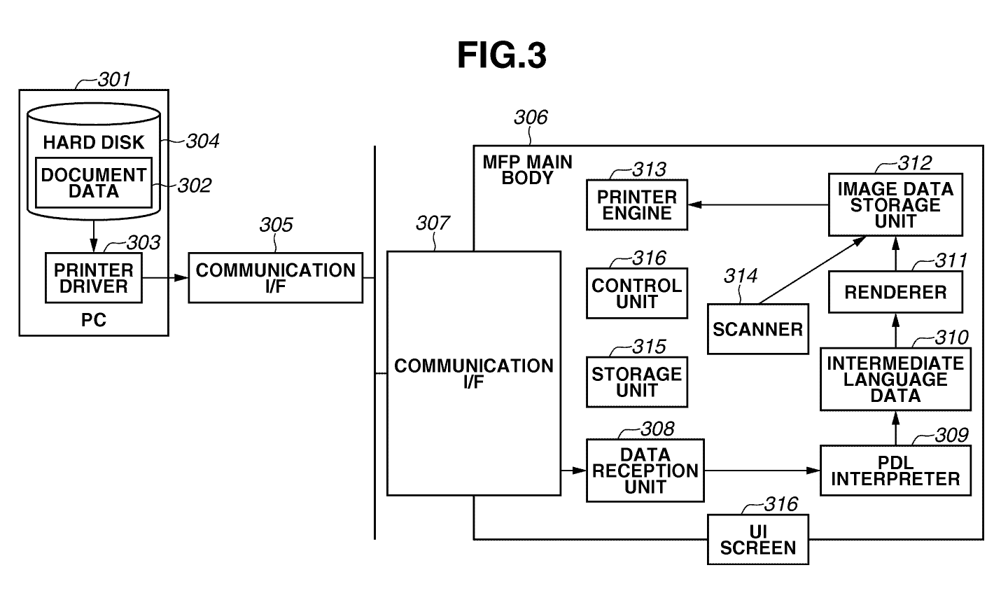

An example of a configuration of a device is described below with reference to FIG. 3.

FIG. 3 is a block diagram illustrating a configuration of each device that constructs the printing system.

A host PC 301 is identical to the host PC 101 illustrated in FIG. 1.

The host PC 301 includes document data 302 generated by an application stored in the host PC 101.

The host PC 301 further includes a printer driver 303 that can generate print data (PDL data) based on the document data 302. In the exemplary embodiment, the PDL data is page description language, such as PS, PCL, and LIPS.

A hard disk 304 stores the document data 302, the printer driver 303, and the application that can generate the document data 302.

A communication interface 305 can transmit the PDL data generated by the printer driver 303.

While illustrated in a block diagram, a main body 306 of the MFP is similar to that of the MFP 102 illustrated in FIG. 1.

A communication interface (i.e., communication I/F) 307 can receive PDL data sent from the host PC 301.

A data reception unit 308 can store the data input via the communication interface 307.

A PDL interpreter 309 can analyze the PDL data received by the data reception unit 308.

Intermediate language data 310 is output from the PDL interpreter 309. More specifically, the PDL interpreter 309 analyzes the PDL data received by the data reception unit 308 and converts the PDL data into the intermediate language data 310.

A renderer 311 can analyze the intermediate language data 310 and can convert the intermediate language data 310 into image data.

An image data storage unit 312 can store a processing result generated by the renderer 311.

A printer engine 313 can convert the image data stored in the image data storage unit 312 into a video signal and prints the image data.

The main body 306 of the MFP includes a reading scanner 314 that can read an original.

A storage unit 315 can store device setting values and the image data.

A control unit 316 can execute predetermined processing according to programs, which relate to various processing according to the present exemplary embodiment.

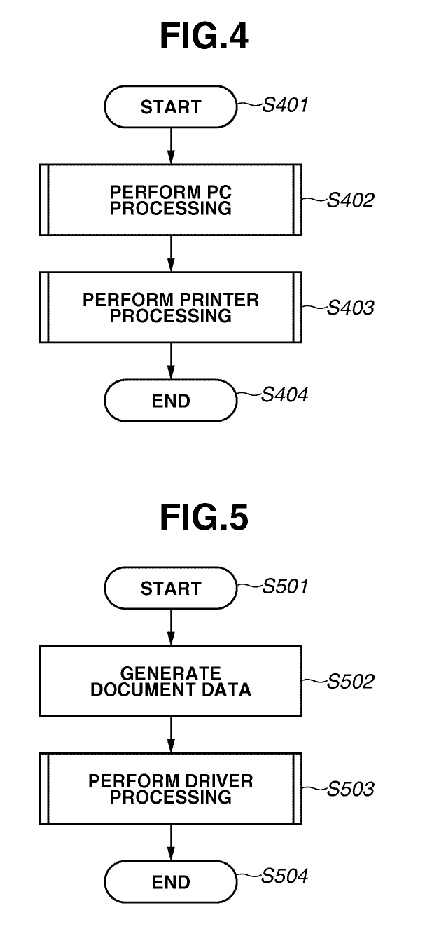

An overall processing flow of the present system using the PDL data is described below with reference to a flowchart illustrated in FIG. 4. FIG. 4 is a flowchart illustrating an example of printer processing that can be performed by the printing system.

In step S401, the printing system starts the processing routine of the flowchart illustrated in FIG. 4.

In step S402, the printing system performs PC processing. In the present exemplary embodiment, the printing system generates print data and PDL data using an application (not illustrated) installed on the host PC 101 and the printer driver 303. The PC processing is described below in more detail with reference to a flowchart illustrated in FIG. 5.

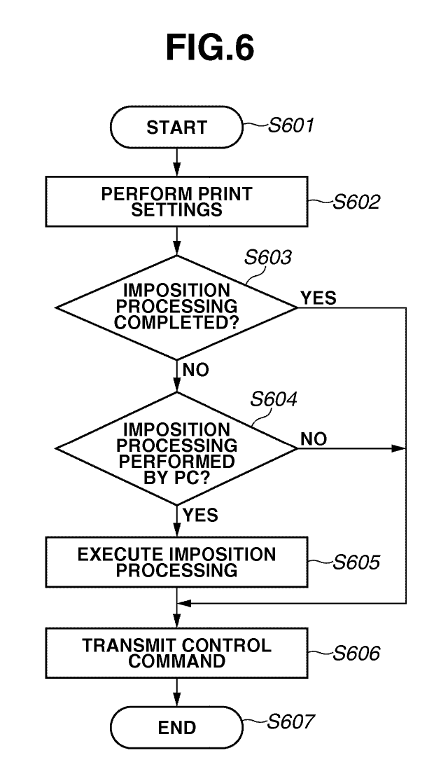

In step S403, the printing system performs the printer processing. In the present exemplary embodiment, the MFP 102 performs processing for printing an image on a sheet. The printer processing is described below in more detail with reference to a flowchart illustrated in FIG. 6.

In step S404, the printing system terminates the processing routine of the flowchart illustrated in FIG. 4.

An example of the PC processing is described below with reference to the flowchart illustrated in FIG. 5. The CPU of the PC can execute the processing of each step illustrated in FIG. 5.

In step S501, the host PC 101 starts the PC processing.

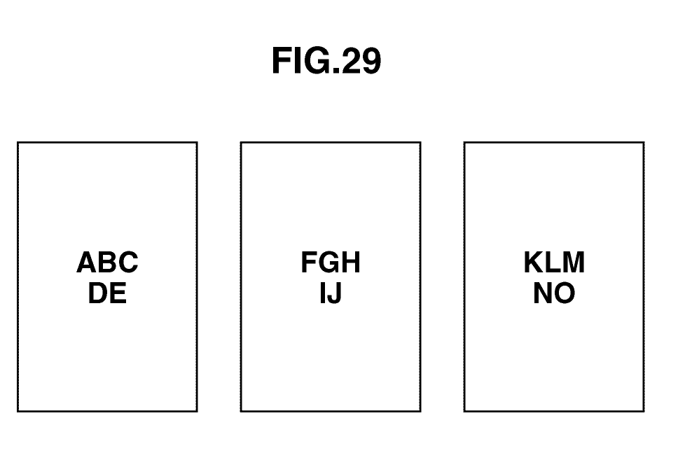

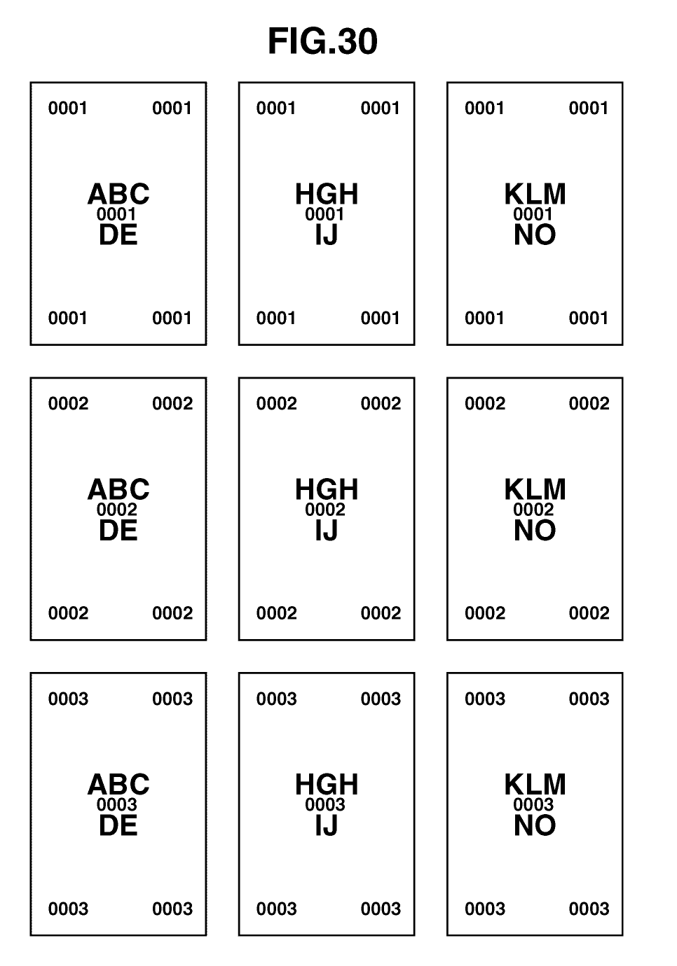

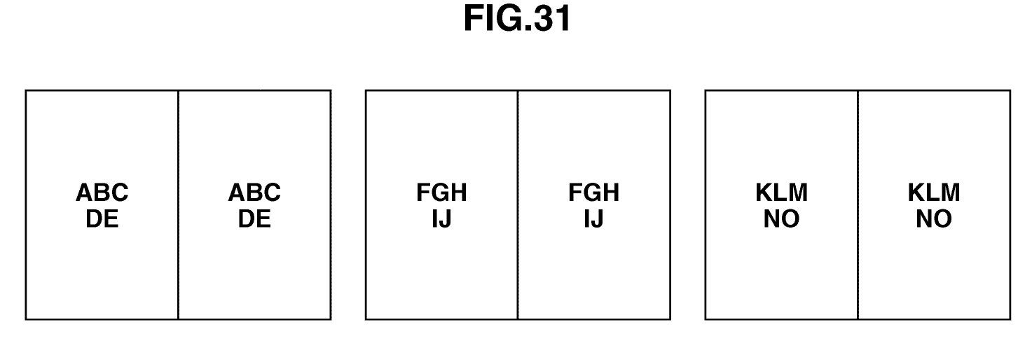

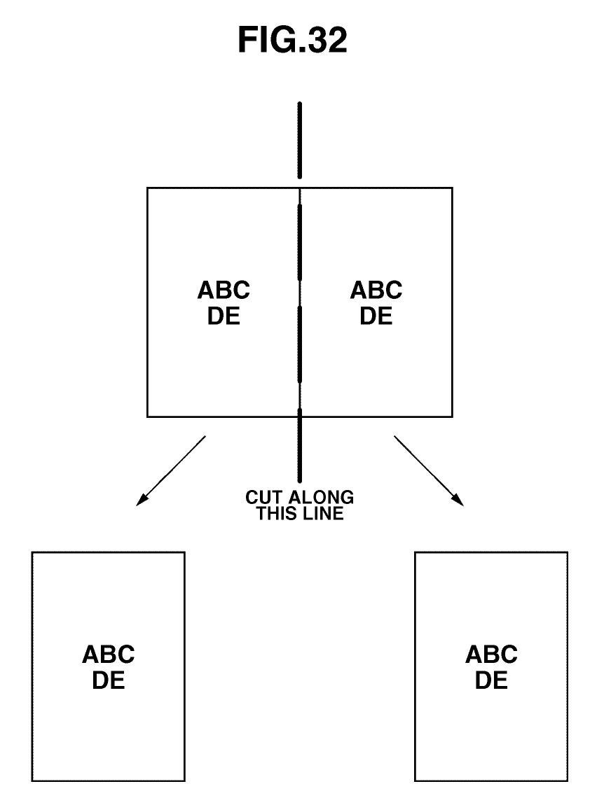

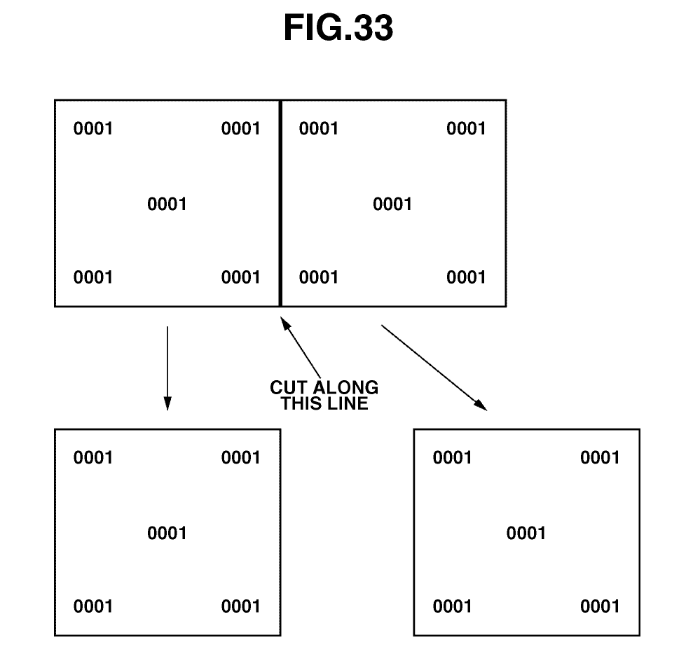

In step S502, an application (not illustrated) installed on the host PC 101 performs generation of document data. There are two types of document data generated by the application (see FIG. 29 and FIG. 31).

First, the document data illustrated in FIG. 29 is described below. FIG. 29 illustrates an example of document data of one page allocated to each sheet.

FIG. 31 illustrates an example of document data of two same pages allocated on each sheet, which can be obtained though the “page iterative” processing. In the exemplary embodiment, the printing system can generate the document data illustrated in FIG. 29 or FIG. 31.

In step S503, the printer driver 303 of the host PC 101 performs, as driver processing, generation of PDL data. The driver processing is described below in more detail with reference to the flowchart illustrated in FIG. 6.

In step S504, the host PC 101 terminates the processing routine of the flowchart illustrated in FIG. 5.

Next, an example of the driver processing is described below with reference to the flowchart illustrated in FIG. 6. The CPU of the PC can execute the processing of each step illustrated in FIG. 6.

In step S601, the printer driver 303 starts the driver processing.

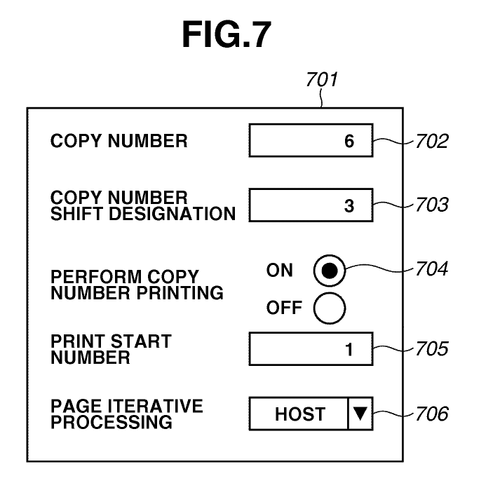

In step S602, the printer driver 303 sets print setting values based on user's setting entered via a driver user interface (UI). The settings to be performed by the printer driver 303 are described below with reference to FIG. 7.

FIG. 7 illustrates an example of the driver UI. A driver UI 701 includes a copy number setting field 702 that enables users to set a copy number (i.e., the number of copies to be output). The driver UI 701 includes a copy number shift designation input field 703 that enables users to input a copy number as units to be shifted.

The driver UI 701 includes ON/OFF setting buttons 704 for designating copy number printing. If a user designates the copy number printing, the user can select the ON button. If the user does not designate the copy number printing, the user can select the OFF button.

In the present exemplary embodiment, if the ON button is selected, the printing system prints document numbers on printed documents. The driver UI 701 includes a document number (serial number) start number input field 705. The input value in the field 706 is added to the first document.

The driver UI 701 includes a “page iterative processing” field 706 that enables users to designate a place where the “page iterative processing” is performed. In the present exemplary embodiment, the input of the “page iterative processing” field 706 is selectable from four choices “not performed”, “processing completed”, “host”, and “printer.”

If in step S502 the “page iterative processing” is executed by the application, the user can select the “processing completed” in the “page iterative processing” field 706. On the other hand, if the “page iterative processing” is executed by the driver, the user can select the “host” in the “page iterative processing” field 706. The printer driver generates print data to generate a printed product based on the setting contents having been set using the UI (i.e., a setting screen) illustrated in FIG. 7. The printer driver outputs the generated print data to the printer.

In step S603, the printer driver 303 determines whether the imposition processing has been completed. In the present exemplary embodiment, an imposition processing completed state indicates that the application has already executed the “page iterative processing.”

In this case, the choice “processing completed” is set in the field 706 in step S602. On the other hand, if the “page iterative processing” has not been executed by the application, the choice “host” or “printer” is set in the field 706 in step S602.

If in step S602 the choice “processing completed” is set in the field 706, the printer driver 303 determines that the imposition processing has been completed and issues a page iterative imposition command and then proceeds to step S606. On the other hand, if the choice “host” or “printer” is set in the field 706 in step S602, the printer driver 303 determines that the imposition processing has not been completed yet (NO in step S603) and then proceeds to step S604.

In step S604, the printer driver 303 determines whether the PC performs the imposition processing. If in step S602 the choice “host” is set in the field 706, the printer driver 303 determines that the host performs the imposition processing (YES in step S604) and proceeds to step S605.

On the other hand, if in step S602 the choice “printer” is set in the field 706, the printer driver 303 determines that the printer performs the imposition processing (NO in step S604), and the printer driver 303 proceeds to step S606.

In step S605, the printer driver 303 executes the imposition processing for a “page iterative” layout. In the present exemplary embodiment, the printer driver 303 generates PDL data realizing the imposition illustrated in FIG. 31 which is derived from the document data illustrated in FIG. 29. Then, the printer driver 303 issues the page iterative imposition command.

In step S606, the printer driver 303 transmits the generated PDL data or the information set in step S602, as a control command, to the MFP 102.

In step S607, the printer driver 303 terminates the processing routine of the flowchart illustrated in FIG. 6.

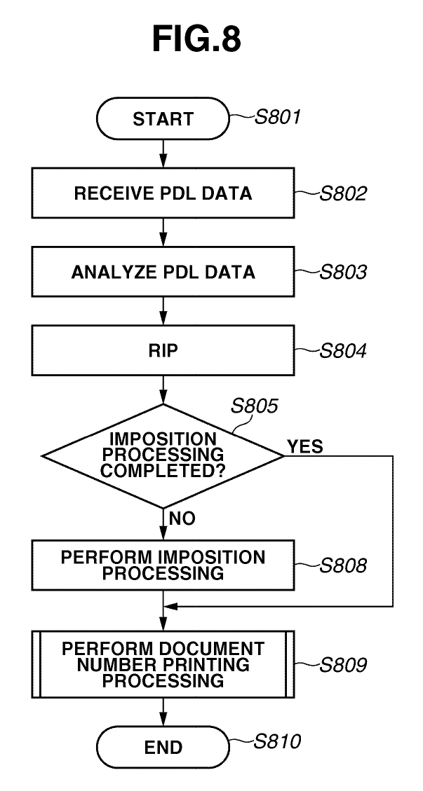

Next, an example of the printer processing is described below with reference to a flowchart illustrated in FIG. 8. The control unit 316 of the printer can execute the processing of each step illustrated in FIG. 8.

In step S801, the MFP 102 (i.e., MFP 306) starts the printer processing.

In step S802, the MFP 102 receives, via the communication I/F 307, the PDL data transmitted by the printer driver 303.

In step S803, the MFP 102 analyzes the received PDL data using the PDL interpreter 309. Then, the PDL interpreter 309 successively generates the intermediate language data 310 based on the received PDL data. The intermediate language data includes “bitmap”, “run-length”, “trapezoid”, “box”, “high-speed boundary encoded bitmap” and other rendering objects, background patterns, and rendering logics to be used when the above-described data are rendered on a raster memory.

In step S804, the MFP 102 performs RIP processing. The MFP 102 stores the image data converted from the intermediate language data, the number of pages that can be obtained through the RIP processing, and the copy number having been set by the driver (see step S602) in the storage unit 315.

In step S805, the control unit 316 of the MFP 102 determines whether the imposition processing has been completed. In this case, the imposition processing completed state indicates that the page iterative imposition has been executed by the host.

The control unit 316 can execute the processing of step S805 based on the result analyzed by the PDL interpreter 309. If it is determined that the imposition processing has been completed (YES in step S805), the control unit 316 proceeds to step S809. On the other hand, if it is determined that the imposition processing has not been completed (NO in step S805), the control unit 316 proceeds to step S808.

In step S808, the control unit 316 performs the imposition processing for the “page iterative” layout. In the present exemplary embodiment, the control unit 316 performs layout imposition as illustrated in FIG. 31. Then, the control unit 316 stores a result of the layout imposition in the storage unit 315.

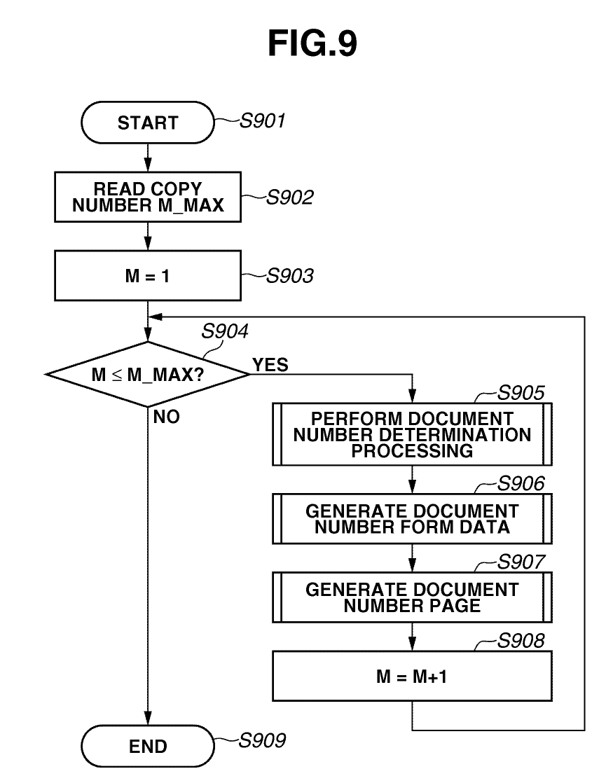

In step S809, the control unit 316 performs document number print processing (i.e., document number adding processing). The document number print processing is described below in more detail with reference to a flowchart illustrated in FIG. 9.

In step S810, the MFP 102 terminates the processing routine of the flowchart illustrated in FIG. 8.

Next, the document number print processing is described below with reference to a flowchart illustrated in FIG. 9. FIG. 9 is a flowchart illustrating an example of the document number print processing. The control unit 316 can execute the processing of each step.

In step S901, the control unit 316 starts document number print processing.

In step S902, the control unit 316 reads the copy number (M_MAX) having been set (or stored) in step S804 from the storage unit 315. In this case, M_MAX is a positive integer.

In step S903, the control unit 316 initializes a variable M that indicates a currently processed document (i.e., M=1). In the present exemplary embodiment, the variable M is a positive integer.

In step S904, the control unit 316 compares the currently processed document number M with the copy number (M_MAX). If it is determined that the currently processed document number M is equal to or less than the copy number M_MAX (YES in step S904), the control unit 316 proceeds to step S905. On the other hand, if it is determined that the currently processed document number M is greater than the copy number M_MAX (NO in step S904), the control unit 316 proceeds to step S909.

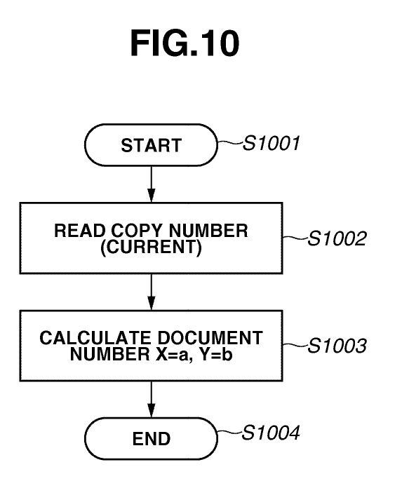

In step S905, the control unit 316 performs document number determination processing for determining a document number to be added to the currently processed document. The document number determination processing is described below in more detail with reference to a flowchart illustrated in FIG. 10.

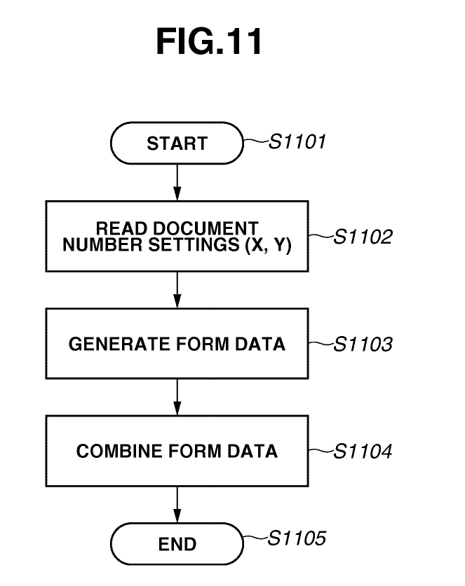

In step S906, the control unit 316 generates document number form data to be added to the currently processed document using the document number determined in step S905. The generation of the document number form data is described below in more detail with reference to a flowchart illustrated in FIG. 11.

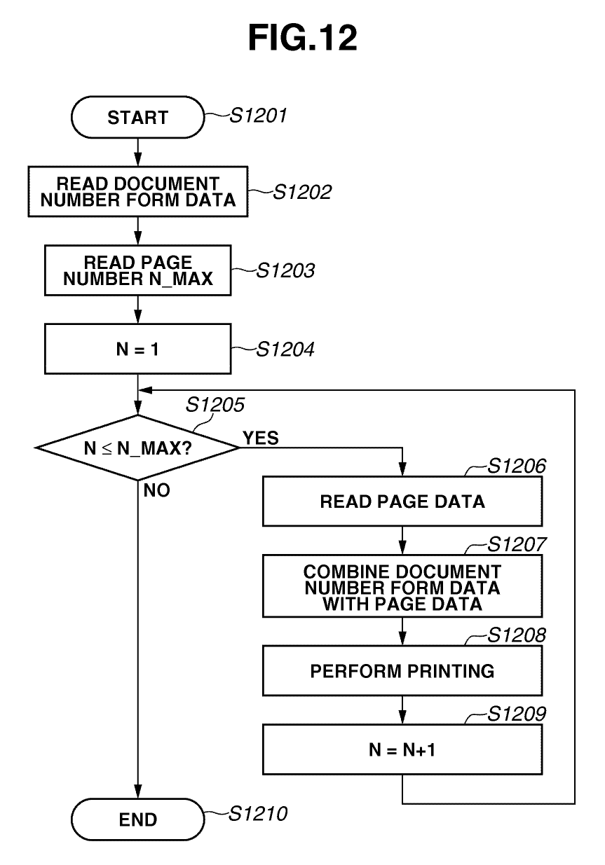

In step S907, the control unit 316 combines the document number form data generated in step S906 with the image data generated in step S804 to generate a document number page. The generation of the document number page is described below in more detail with reference to a flowchart illustrated in FIG. 12.

In step S908, the control unit 316 increments the copy number M indicating the currently processed document.

In step S909, the control unit 316 terminates the processing routine of the flowchart illustrated in FIG. 9.

An example of the document number determination processing is described below with reference to the flowchart illustrated in FIG. 10. FIG. 10 is a flowchart illustrating an example of the document number determination processing (version I).

In step S1001, the control unit 316 starts document number determination processing.

In step S1002, the control unit 316 reads the copy number M (current) indicating the currently processed document from the storage unit 315.

In step S1003, the control unit 316 calculates document numbers to be added. In the present exemplary embodiment, it is assumed that the driver settings (see step S602) include copy number=3, print start number=1, and copy number shift designation=0. In the case of the copy processing, the settings can be performed using the UI in step S1603.

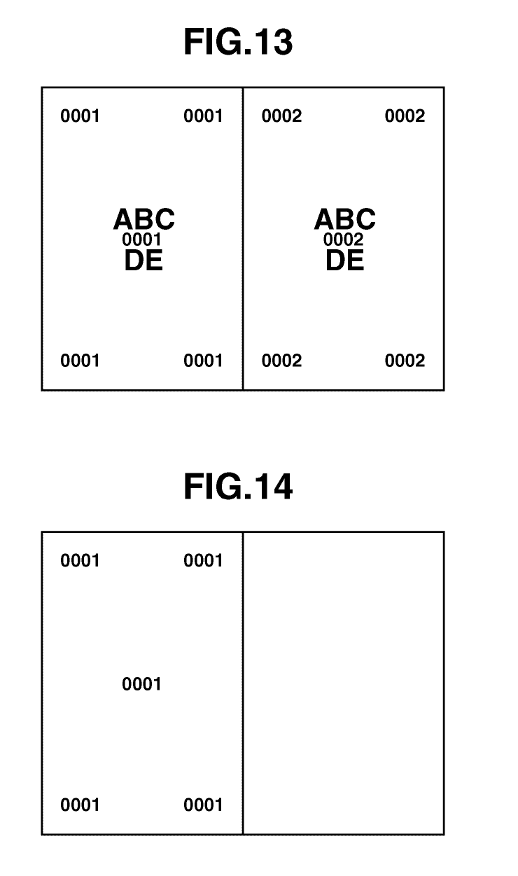

In this case, the control unit 316 adds a document number 0001 (the print start number is expressed as a 4-digit value) to the left-hand page and a document number 0002 to the right-hand page, for each sheet of the first document (see FIG. 13).

FIG. 13 illustrates an example of a print layout (version I). Then, the control unit 316 obtains a document number to be imposed on a plane of a sheet according to the following formula.

In the present exemplary embodiment, when “a” represents the number of pages to be imposed on the plane of the sheet, and “i” (1≦i≦a) represents position information on the plane of the sheet, the document number to be imposed on the plane of the sheet can be expressed by the following formula.

“Document number to be imposed on sheet”=1+a(M−1)+(i−1)

For example, if imposing two logical pages on a single plane of a sheet is set, page position information 1 is allocated to the left-hand page and page position information 2 is allocated to the right-hand page. Further, a document number (variable) imposed on the left-hand page is X and a document number (variable) imposed on the right-hand page is Y. These data are stored in the storage unit 315.

In this case, the values X and Y can be derived from the above-described formula in the following manner.

X=1+2(1−1)+(1−1)

Y=1+2(1−1)+(2−1).

As a result, a document number “1” is imposed on the left side and a document number “2” is imposed on the right side of the plane of the sheet of the first document. The position information can be determined based on the imposition order. In the above-described case, the imposition order is designated in the direction from left to right.

In step S1004, the control unit 316 terminates the processing routine of the flowchart illustrated in FIG. 10.

An example of document number form generation is described below with reference to the flowchart illustrated in FIG. 11. FIG. 11 is a flowchart illustrating an example of document number form generation processing.

In step S1101, the control unit 316 starts the document number form generation processing. In step S1102, the control unit 316 reads the variables X and Y from the storage unit 315, which are stored in the document number calculation step (see step S1003).

In step S1103, the control unit 316 generates form data. More specifically, the control unit 316 generates document number form data using the variable X (see FIG. 14). FIG. 14 illustrates an example of the form data (version I).

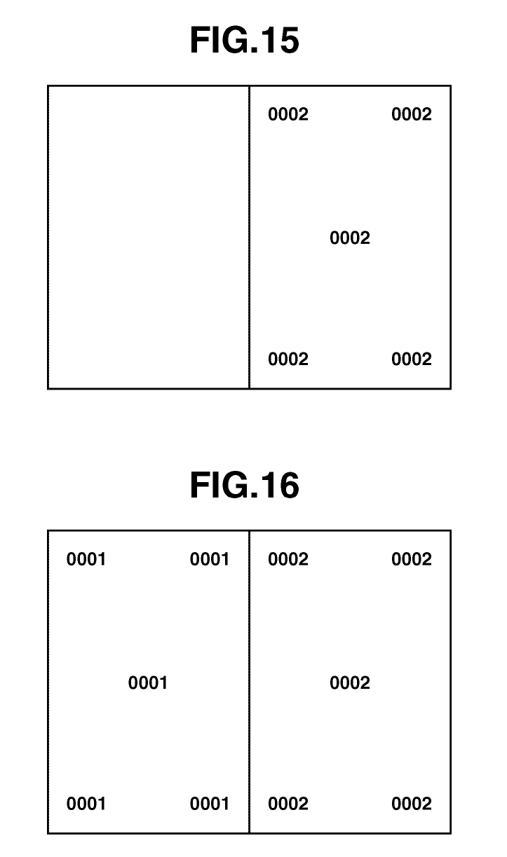

Next, the control unit 316 generates form data using the variable Y (see FIG. 15). FIG. 15 illustrates an example of the form data (version II).

In step S1104, the control unit 316 combines the form data generated in step S1103. More specifically, the control unit 316 combines the form data generated using the variable X (see FIG. 14) with the form data generated using the variable Y (see FIG. 15).

Then, the control unit 316 generates new form data (see FIG. 16). Then, the control unit 316 stores the generated form data in the storage unit 315. FIG. 16 illustrates an example of the form data (version III).

In step S1105, the control unit 316 terminates the processing routine of the flowchart illustrated in FIG. 11.

The generation of the document number page is described below with reference to the flowchart illustrated in FIG. 12. FIG. 12 is a flowchart illustrating an example of document number page generation processing.

In step S1201, the control unit 316 starts the document number page generation processing.

In step S1202, the control unit 316 reads the document number form data (see FIG. 16) generated in step S1104 from the storage unit 315.

In step S1203, the control unit 316 reads a total page number N_MAX, which has been obtained in the processing in step S804, from the storage unit 315.

In step S1204, the control unit 316 initializes a variable N indicating a current page number (i.e., N=1). In the present exemplary embodiment, N is a positive integer.

In step S1205, the control unit 316 compares the current page number N with the total page number N_MAX. If it is determined that the current page number N is equal to or less than the total page number N_MAX (YES in step S1205), the control unit 316 proceeds to step S1206. On the other hand, if it is determined that the current page number N is greater the total page number N_MAX (NO in step S1205), the control unit 316 proceeds to step S1210.

In step S1206, the control unit 316 reads the data indicating the current page number N from the page data generated in step S804, which is stored in the storage unit 315.

In step S1207, the control unit 316 combines the document number form data (see FIG. 16) read in step S1202 with the page data read in step S1206.

In step S1208, the control unit 316 transmits a video signal representing the data combined in step S1207 to the printer engine 313. The printer engine 313 prints the data on a sheet (not illustrated).

In step S1209, the control unit 316 increments the current page number N by one (i.e., N=N+1).

In step S1210, the control unit 316 terminates the processing routine of the flowchart illustrated in FIG. 12.

As described above, according to the exemplary embodiment, the control unit 316 can add different document numbers to logical pages to be imposed on a physical page, with respect to data having been subjected to the page iterative imposition. Therefore, even when print data of a plurality of the same pages are imposed on a plane of a sheet by the page iterative imposition, the present exemplary embodiment can prevent a plurality of documents (products) having the same document number from been generated.

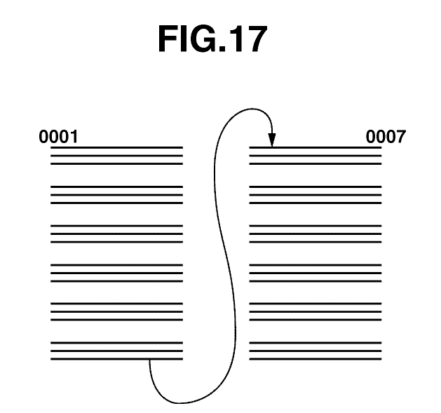

According to the first exemplary embodiment, in the document number determination processing illustrated in FIG. 10, the copy number (current) is read and the document number is determined. However, in the post processing (which is, for example, performed by the cutting machine), two or more cutting-processed products may be stacked as illustrated in FIG. 17 when they are packed in a corrugated fiberboard box.

FIG. 17 illustrates an example of document number determination (version I) according to a second exemplary embodiment. In this case, if the document numbers are allocated as described in the first exemplary embodiment, the document numbers may not be correctly arranged in numerical order. Hence, the following method can be used to determine document numbers.

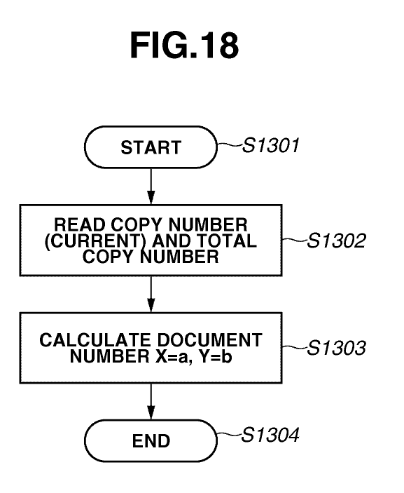

An example of the document number determination processing according to another method is described below with reference to a flowchart illustrated in FIG. 18. FIG. 18 is a flowchart illustrating an example of the document number determination processing (version II).

The processing illustrated in FIG. 18 can be executed when a user instructs the apparatus to stack cutting-processed documents via the UI of the printer driver 303.

In step S1301, the control unit 316 starts the document number determination processing.

In step S1302, the control unit 316 reads the copy number M (current) indicating the currently processed document and a total copy number K from the storage unit 315.

In step S1303, the control unit 316 calculates document numbers to be added. In the present exemplary embodiment, it is assumed that the driver settings (see step S602) include copy number=6 and print start number=1. In the case of the copy processing, the settings can be performed using the UI in step S1603.

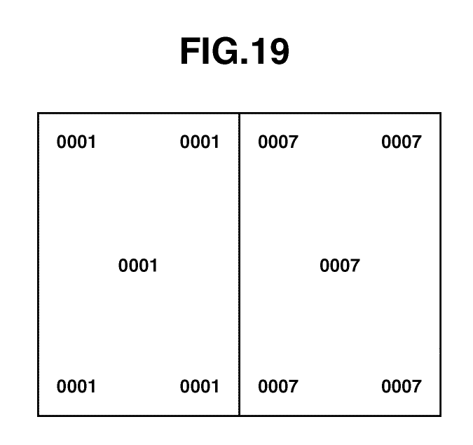

The control unit 316 adds a document number 0001 (the print start number is expressed as a 4-digit value) to the left-hand page and a document number 0007 to the right-hand page for each sheet of the first document (see FIG. 19).

FIG. 19 illustrates an example of the form data (version IV).

In the present exemplary embodiment, the control unit 316 adds document numbers to respective documents considering the post-processing by which the cutting-processed documents are stacked as illustrated in FIG. 17. In short, when two or more cutting-processed documents are stacked, their document numbers are continuously arranged in numerical order. Thus, a document having a document number 0006 is followed by the document having the document number 0007.

A document number calculation method according to the present exemplary embodiment is described below. When “a” represents the number of pages to be imposed on the plane of a sheet, and “i” (1≦i≦a) represents position information on the plane of the sheet, the document number to be imposed on the plane of the sheet according to the second exemplary embodiment can be expressed by the following formula.

“Document number to be imposed on sheet”=1+(M−1)+k(i−1)

In the above-described formula, k is a value representing the copy number (e.g., k=6 in the above-described example).

For example, if imposing two logical pages on a single plane of a sheet is set, page position information 1 is allocated to the left-hand page and page position information 2 is allocated to the right-hand page. Further, a document number (variable) imposed on the left-hand page is X and a document number (variable) imposed on the right-hand page is Y. These data are stored in the storage unit 315.

In this case, the values X and Y can be derived from the above-described formula in the following manner.

X=1+(1−1)+6(1−1)

Y=1+(1−1)+6(2−1).

As a result, the document number “1” is imposed on the left side and a document number “7” is imposed on the right side of the plane of the sheet of the first document.

In step S1304, the control unit 316 terminates the processing routine of the flowchart illustrated in FIG. 18.

As described above, the second exemplary embodiment can obtain an output product including a plurality of documents whose document numbers are correctly arranged in numerical order even after the documents are subjected to post-processing (such as “cutting processing”) .

According to the first exemplary embodiment, in the document number determination processing illustrated in FIG. 10, the copy number (current) is read and the document number is determined. Further, according to the second exemplary embodiment, the document number is determined considering the total copy number (i.e., based on the total copy number).

However, in a case where a copy number shift designation is set, print products separated into a plurality of groups for the copy number shift designation may be processed after the post-processing (e.g., cutting). In this case, if document numbers are allocated according to the first exemplary embodiment and the second exemplary embodiment, the document numbers in the copy number shift designation may not be accurately arranged in the order intended by a user.

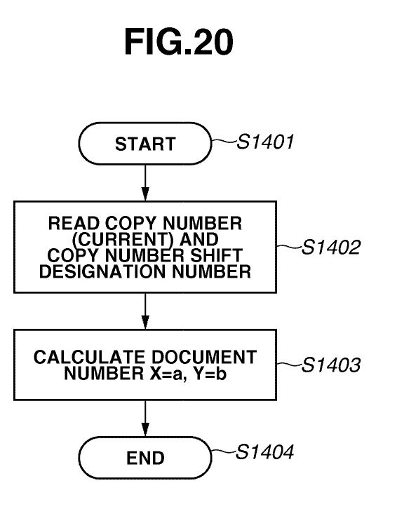

Hence, a method according to the following third exemplary embodiment can be used to determine document numbers. An example of the document number determination processing according to another method is described below with reference to FIG. 20. FIG. 20 is a flowchart illustrating an example of the document number determination processing (version III).

In step S1401, the control unit 316 starts the document number determination processing.

In step S1402, the control unit 316 reads the copy number M (current) indicating the currently processed document and a copy number shift designation copy number L from the storage unit 315.

In step S1403, the control unit 316 calculates document numbers to be added. In the third exemplary embodiment, it is assumed that the driver settings (step S602) include copy number=6, print start number=1, and copy number shift designation=3. (In the case of the copy processing, the settings can be performed using the UI in step S1603).

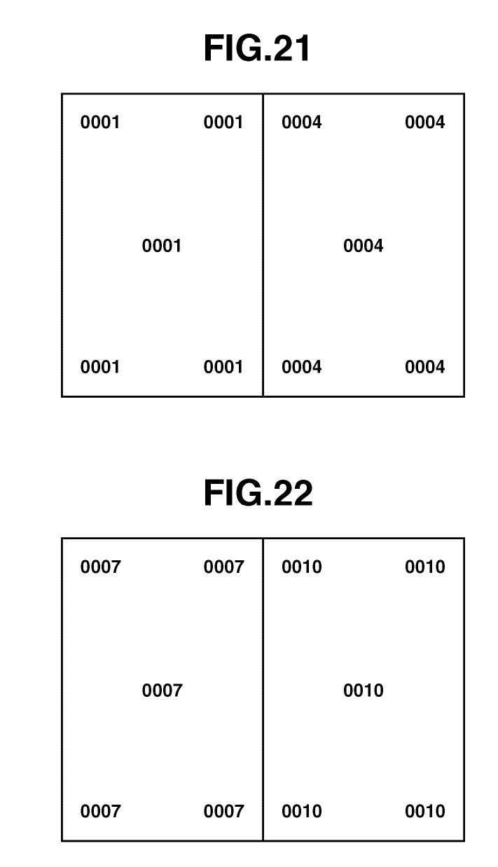

Further, it is assumed that the control unit 316 adds a document number 0001 (the print start number is expressed as a 4-digit value) to the left-hand page and a document number 0004 to the right-hand page for each sheet of the first document (i.e., the first document subjected to the copy number shift designation) (see FIG. 21). FIG. 21 illustrates an example of the form data (version V).

Further, it is assumed that the control unit 316 adds a document number 0007 (the print start number is expressed as a 4-digit value) to the left-hand page and a document number 0010 to the right-hand page for each sheet of the fourth document (i.e., the second document subjected to the copy number shift designation) (see FIG. 22).

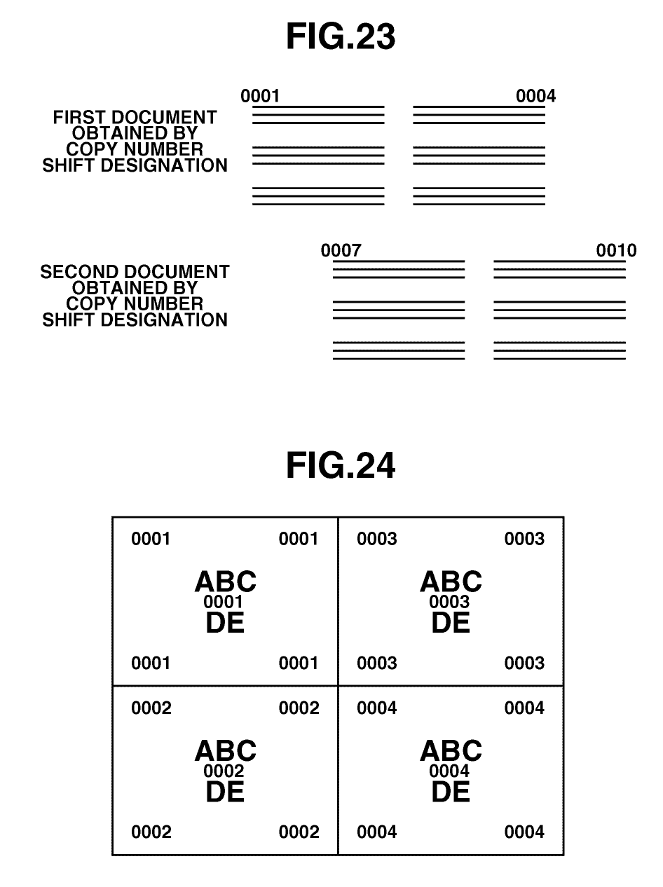

FIG. 22 illustrates an example of the document number determination (version II). The example intends to add document numbers based on the units of the shift designation copy number, as illustrated in FIG. 23. FIG. 23 illustrates an example of the document number determination (version III).

The control unit 316 sets the variable X to 0001 (i.e., X=0001) and the variable Y to 0004 (i.e., Y=0004), in which the variable X is a value imposed on the left-hand page and the variable Y is a value imposed on the right-hand page of the first document (to be subjected to the copy number shift designation). The set values can be stored in the storage unit 315. In this case, the values X and Y can be derived using the following formula. In the following formula, K represents a copy number shift designation number.

X=1+2K(M−1)

Y=X+L

In step S1404, the control unit 316 terminates the processing routine of the flowchart illustrated in FIG. 20.

The above-described exemplary embodiment has described the processing for imposing two pages on the plane of a piece of sheet according to the page iterative imposition. However, for example, four pages can be imposed on the plane of a piece of a sheet as illustrated in FIG. 24. In general, an imposition of M×N pages (M and N are positive integers) can be realized. FIG. 24 illustrates an example of the print layout (version II) according to a fourth exemplary embodiment.

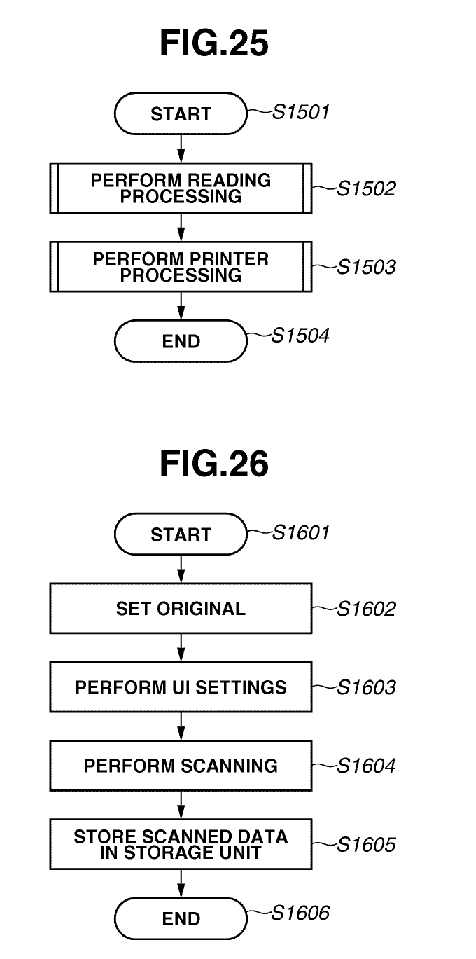

An example of the copy processing that can be performed by the present system according to a fifth exemplary embodiment is described below with reference to a flowchart illustrated in FIG. 25. FIG. 25 is a flowchart illustrating an example of the copy processing that can be performed by the printing system.

In step S1501, the control unit 316 starts the processing routine of the flowchart illustrated in FIG. 25.

In step S1502, the control unit 316 performs reading processing. In the present exemplary embodiment, the control unit 316 performs processing for reading an original using the scanner 207 (or the scanner 314). The reading processing is described below in more detail with reference to a flowchart illustrated in FIG. 26.

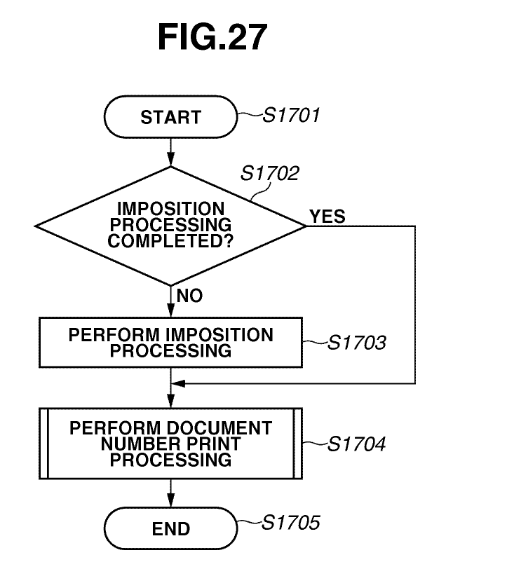

In step S1503, the control unit 316 performs control for the printer processing. In the present exemplary embodiment, the printer processing includes generating print data using the MFP 102 and performing print processing on a sheet. The printer processing is described below in more detail with reference to a flowchart illustrated in FIG. 27.

In step S1504, the control unit 316 terminates the processing routine of the flowchart illustrated in FIG. 25.

Next, an example of the reading processing is described below with reference to a flowchart illustrated in FIG. 26. FIG. 26 is a flowchart illustrating an example of the reading processing.

In step S1601, the control unit 316 starts the reading processing.

In step S1602, a user sets an original to be copied on the automatic document feeder 207. The control unit 316 (or the automatic document feeder 207) detects the original having been set.

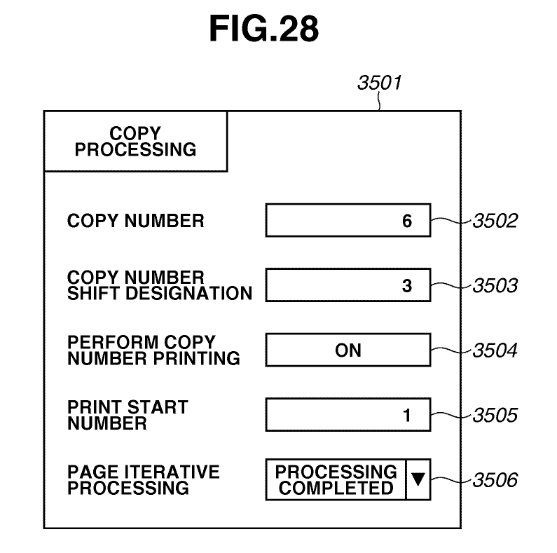

In step S1603, the user performs settings for the copy processing using the UI equipped in the MFP 102. The settings of the copy processing are described below with reference to a UI illustrated in FIG. 28. FIG. 28 illustrates an example of the UI that can be used for settings of the copy processing.

A user interface (UI) 3501 includes a copy number setting field 3502 that enables users to set a copy number (i.e., the number of copies to be output). The UI 3501 includes a copy number shift designation input field 3503 that enables users to input a copy number as units to be shifted.

The UI 3501 includes an ON/OFF setting field 3504 for designating the copy number printing.

If a user designates the copy number printing, the user can select ON. If the user does not designate the copy number printing, the user can select OFF.

The UI 3501 includes a document number (serial number) starting number input field 3505. The input value in the field 3505 is added to the first document. The UI 3501 includes a “page iterative processing” field 3506 that enables users to designate a place where the “page iterative processing” is performed.

If the “page iterative processing” is executed, a determination whether the imposition is already performed on the original is input in the field 3506.

In the present exemplary embodiment, the input of the “page iterative processing” field 3506 is selectable from three choices “not performed”, “page iterative processing completed”, and “page iterative unprocessed.”

The control unit 316 can receive setting information entered via the UI.

In step S1604, the control unit 316 causes the automatic document feeder 207 to feed the original to the scanner 314. The scanner 314 reads the original.

In step S1605, the control unit 316 stores the scanned original data having been read in step S1604 in the storage unit 315.

In step S1606, the control unit 316 terminates the processing routine of the flowchart illustrated in FIG. 26.

Next, an example of the printer processing is described below with reference to a flowchart illustrated in FIG. 27. FIG. 27 is a flowchart illustrating an example of the printer processing (version II).

In step S1701, the control unit 316 starts printer processing.

In step S1702, the control unit 316 determines whether the data stored in the storage unit 315 is in an imposition processing completed state. In this case, the imposition processing completed state indicates that an imposition according to the page iterative processing is already applied to the original read in step S1604.

The control unit 316 can determine whether the imposition processing has been completed referring to the contents having been set in step S1603. In the present exemplary embodiment, the setting values (i.e., setting information) can be stored in the storage unit 315.

If it is determined that the imposition processing has been completed (YES in step S1702), the control unit 316 proceeds to step S1704. On the other hand, if it is determined that the imposition processing has not been completed (NO in step S1702), the control unit 316 proceeds to step S1703.

In step S1703, the control unit 316 performs the imposition processing for the “page iterative” layout. In the present exemplary embodiment, the control unit 316 reads the document data illustrated in FIG. 29 from the storage unit 315, and performs layout imposition as illustrated in FIG. 31. Then, the control unit 316 stores a result of the layout imposition in the storage unit 315.

In step S1704, the control unit 316 performs document number print processing. The document number print processing is similar to the processing described in the first exemplary embodiment with reference to the flowchart illustrated in FIG. 9.

In step S1705, the control unit 316 terminates the processing routine of the flowchart illustrated in FIG. 27.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2008-275977 filed Oct. 27, 2008, which is hereby incorporated by reference herein in its entirety.

What is claimed is:

1. An information processing apparatus comprising:
a setting unit configured to set printing document numbers that can be used to manage printed products on a document-by-document basis and executing a page iterative imposition for imposing a plurality of same pages on a plane of a sheet; and
a generation unit configured to generate print data for printing the plurality of same pages on the plane of the sheet according to contents set by the setting unit, so that different document numbers are printed on respective printed products that can be obtained by cutting each sheet on which the plurality of same pages are printed.

2. The information processing apparatus according to claim 1, wherein the generation unit generates the print data based on a total copy number and a number of pages to be imposed on the sheet so that the document numbers can be arranged in numerical order when the printed products having been cut are stacked.

3. The information processing apparatus according to claim 1, wherein if the setting unit sets a shift discharge according to a designated copy number, the generation unit generates the print data based on the copy number designated for the shift discharge and a number of pages to be imposed on a plane of the sheet, so that the document numbers can be arranged in numerical order when the printed products having been cut into a plurality of groups for the shift discharge are stacked.

4. An information processing method comprising:
setting printing document numbers that can be used to manage printed products on a document-by-document basis and executing a page iterative imposition for imposing a plurality of same pages on a plane of a sheet; and
generating print data for printing the plurality of same pages on the plane of the sheet according to contents having been set, so that different document numbers are printed on respective printed products that can be obtained by cutting each sheet on which the plurality of same pages are printed.

5. The information processing method according to claim 4, further comprising generating the print data based on a total copy number and a number of pages to be imposed on the sheet so that the document numbers can be arranged in numerical order when the printed products having been cut are stacked.

6. The information processing method according to claim 4, wherein if a shift discharge according to a designated copy number is set, the method further comprises generating the print data based on the copy number designated for the shift discharge and a number of pages to be imposed on a plane of the sheet, so that the document numbers can be arranged in numerical order when the printed products having been cut into a plurality of groups for the shift discharge are stacked.

7. A storage medium storing a program that causes a computer to execute instructions for information processing, the program comprising:
computer-executable instructions for setting printing document numbers that can be used to manage printed products on a document-by-document basis and executing a page iterative imposition for imposing a plurality of same pages on a plane of a sheet; and
computer-executable instructions for generating print data for printing the plurality of same pages on the plane of the sheet according to contents having been set, so that different document numbers are printed on respective printed products that can be obtained by cutting each sheet on which the plurality of same pages are printed.

8. The storage medium according to claim 7, further comprising computer-executable instructions for generating the print data based on a total copy number and a number of pages to be imposed on the sheet so that the document numbers can be arranged in numerical order when the printed products having been cut are stacked.

9. The storage medium according to claim 7, wherein if a shift discharge according to a designated copy number is set, the program further comprises computer-executable instructions for generating the print data based on the copy number designated for the shift discharge and a number of pages to be imposed on a plane of the sheet, so that the document numbers can be arranged in numerical order when the printed products having been cut into a plurality of groups for the shift discharge are stacked.
